(19) United States
(12) Patent Application Publication
(10) Pub. No.: US 2017/0131868 A1
(43) Pub. Date: May 11, 2017

(54) METHOD AND ELECTRONIC DEVICE FOR REPLACING APPLICATION ICON

(71) Applicants: LE HOLDINGS (BEIJING) CO., LTD., Beijing (CN); Lemobile Information Technology (Beijing) Co., Ltd, Beijing (CN)

(72) Inventor: Jingyu Hu, Beijing (CN)

(21) Appl. No.: 15/245,121

(22) Filed: Aug. 23, 2016

Related U.S. Application Data
(63) Continuation of application No. PCT/CN2016/088384, filed on Jul. 4, 2016.

(30) Foreign Application Priority Data
Nov. 6, 2015 (CN) 201510756452.7

(51) Int. Cl. G06F 3/0481; G06T 11/00; G06T 7/40

(52) U.S. Cl. CPC G06F 3/04817; G06T 7/408; G06T 7/403; G06T 11/001

(57) ABSTRACT

The embodiment of the present disclosure discloses the method and electronic device for replacing the application icon. The method is applied to the terminal, and the wallpaper and the application icon are displayed on the desktop of the terminal. The method includes the following steps of: monitoring whether the wallpaper is changed; if yes, determining the color histogram statistic value of the background wallpaper according to the pixel value of each pixel of the background wallpaper which corresponds to the application icon; calculating the Bhattacharyya coefficient between the color histogram statistic value of the application icon and the color histogram statistic value of the background wallpaper; displaying the application icon with the highest Bhattacharyya coefficient on the background wallpaper. The method and electronic device for replacing the application icon are capable of enhancing the color difference of the application icon and the wallpaper.

### CROSS-REFERENCE TO RELATED APPLICATIONS

This application is a continuation of International Application No. PCT/CN2016/088384, filed on Jul. 4, 2016, which claims priority of Chinese patent application No. 201510756452.7, filed on Nov. 6, 2015 and is incorporated herein by reference in its entirety.

### FIELD OF TECHNOLOGY

The present disclosure relates to the technical field of image processing, and particularly relates to method and electronic device for replacing an application icon.

### BACKGROUND

APP (Application) refers to a third-party application of a smartphone, more famous App stores, such as the App Store of Apple, the Google Play Store of android, the Ovi Store of Nokia and the BlackBerry App World of BlackBerry, are known at present.

Many users firstly see APP icons when downloading applications and the users are attracted to click or download nice-looking APP icons. But, the APP icons are probably similar to a wallpaper in color to cause unobvious APP icons as shown in FIG. 1, the APP icons are difficult to find by the users, so that the click times of the APP is reduced and the use probability of the APP is not high.

### SUMMARY

An embodiment of the present disclosure discloses the method and electronic device for replacing the application icon, aiming at overcoming the defect where the click rate of the application icon is not high due to unobvious application icon caused by that the application icon and the background wallpaper are similar or same in color in the prior art and realizing that the application icon is replaced when the application icon and the background wallpaper are approximate or similar in color.

According to one side of the present disclosure, the embodiment of the present disclosure discloses a method for replacing the application icon. The method is applied to a terminal, and the wallpaper and the application icon are displayed on the desktop of the terminal. The method includes the following steps of:

monitoring whether the wallpaper is changed;

if yes, determining a color histogram statistic value of the background wallpaper according to pixel value of each pixel of the background wallpaper which corresponds to the application icon;

calculating a Bhattacharyya coefficient between the color histogram statistic value of the application icon and the color histogram statistic value of the background wallpaper;

displaying the application icon with highest Bhattacharyya coefficient on the background wallpaper.

According to the other side of the present disclosure, the embodiment of the present disclosure also discloses an electronic device for replacing the application icon. The electronic device includes at least one processor; and a memory communicably connected with the at least one processor for storing instructions executable by the at least one processor, wherein execution of the instructions by the at least one processor causes the at least one processor to:

monitor whether the wallpaper is changed;

determine a color histogram statistic value of the background wallpaper according to a pixel value of each pixel of the background wallpaper which corresponds to the application icon if the wallpaper is changed

calculate Bhattacharyya coefficient between the color histogram statistic value of the application icon and the color histogram statistic value of the background wallpaper;

display the application icon with highest Bhattacharyya coefficient on the background wallpaper.

According to another side of the present disclosure, the present disclosure provides a computer program including a computer readable code. When the computer readable code is operated on an electronic device, the method for replacing the application icon is implemented by the electronic device.

According to one more side of the present disclosure, the present disclosure provides a non-transitory computer readable medium storing executable instructions that, when executed by an electronic device, cause the electronic device to:

monitor whether a wallpaper is changed;

determine a color histogram statistic value of the background wallpaper according to a pixel value of each pixel of the background wallpaper which corresponds to the application icon if the wallpaper is changed;

calculate Bhattacharyya coefficient between the color histogram statistic value of the application icon and the color histogram statistic value of the background wallpaper;

display the application icon with highest Bhattacharyya coefficient on the background wallpaper.

The present disclosure has the following beneficial effects:

the method and electronic device for replacing the application icon, which are provided by the present disclosure, are capable of enhancing the color difference of the application icon and the wallpaper by replacing the application icon which has the highest Bhattacharyya coefficient with the background wallpaper in time when the users replace the wallpaper to enable the application icon to be very obvious and attract the users to click the application icon, thereby enhancing the click rate of the application icon.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a diagrammatic drawing on which the application icon and the background wallpaper are similar in color in the prior art.

FIG. 2 is a step flow diagram of the method for replacing the application icon, which is provided by the embodiment of the present disclosure.

FIG. 3 is a diagrammatic drawing of a replaced application icon provided by the embodiment of the present disclosure.

FIG. 4 is the step flow diagram of the method for replacing the application icon, which is provided by the embodiment of the present disclosure.

FIG. 5 is a structure diagram of the device for replacing the application icon, which is provided by the embodiment of the present disclosure.

FIG. 6 is the structure diagram of the device for replacing the application icon, which is provided by the embodiment of the present disclosure.

FIG. 7 schematically shows the diagram of an electronic device used for implementing the method according to the present disclosure.

FIG. 8 schematically shows a storage unit used for maintaining or carrying a program code capable of realizing the method according to the present disclosure.

### DESCRIPTION OF THE EMBODIMENTS

To make the objective, technical solution and advantage of the embodiment of the present disclosure clearer, the technical solution in the embodiment of the present disclosure is clearly and integrally described below combining with the drawings referred to the embodiment of the present disclosure, obviously, the described embodiments are a part of the embodiments of the present disclosure but not all of the embodiments. On the basis of the embodiments of the present disclosure, all other embodiments obtained under the precondition of contributing no creative labor by the ordinary technical personnel in the filed all belong to the range protected by the present disclosure.

RGB color mode is a color standard in industrial circle, various colors are obtained through the change of a red (R) color channel, a green (G) color channel and a blue (B) color channel and the superposition among the red (R) color channel, the green (G) color channel and the blue (B) color channel herein, and the standard almost includes all colors capable of being sensed by human sight and is one of most extensively applied color systems at present.

A color histogram is a color feature widely adopted in a plurality of image retrieval systems. The color histogram describes the proportion of different colors in an integral image but not concerns the space position of each color; that is to say, an object or a substance cannot be described in the image. The color histogram is especially suitable for describing certain images, which are difficult to automatically segment.

On the basis of the above principle, the embodiment of the present disclosure provides the method and an electronic device for replacing the application icon, aiming at overcoming the defect that the click rate of the application icon is not high due to the unobvious application icon caused by that the application icon and the background wallpaper are similar or same in color in the prior art and realizing that the application icon is replaced when the application icon and the background wallpaper are approximate or similar in color.

### First Embodiment

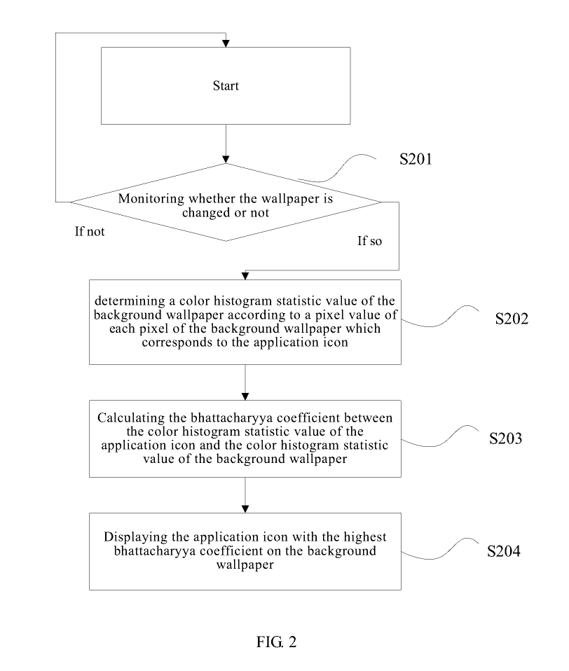

Referring to FIG. 2, the step flow diagram of the method for replacing the application icon, which is provided by the embodiment of the present disclosure, is shown.

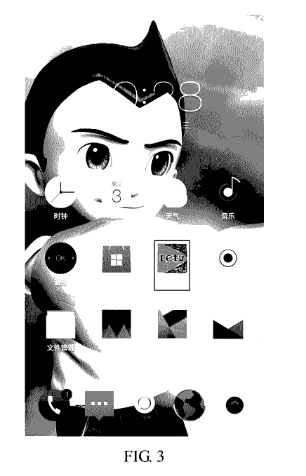

Referring to FIG. 3, the diagrammatic drawing of the replaced application icon provided by the embodiment of the present disclosure is shown.

The embodiment of the present disclosure provides the method for replacing the application icon. The method can be applied to terminals, such as a mobile phone, a flat panel computer and the like, and wallpapers and application icons are displayed on the desktops of the terminals, as shown in FIG. 2, the method includes the following steps.

Step S201, monitoring whether the wallpaper is changed;

in the step S201, a user can change the wallpaper on the desktop of the terminal at any time through the desktop setting function of the terminal; the wallpaper is covered with a plurality of application icons, and the positions and quantity of the application icons cannot be changed; in the embodiment of the present disclosure, if the change of the wallpaper is not monitored, the application icons are not changed, the step S201 is circularly executed, and if the change of the wallpaper is monitored, the operation in the step S202 is executed.

Step S202, determining a color histogram statistic value of the background wallpaper according to a pixel value of each pixel of the background wallpaper which corresponds to the application icon;

in the step S202, the background wallpaper is positioned within a certain range around the application icon, the length of the background wallpaper is less than or equal to the distance between adjacent left and right application icons, the width of the background wallpaper is less than or equal to the distance between adjacent upper and lower application icons, and the length and width of the background wallpaper are both more than the lengths and widths of the application icons; an overlapped area can appear on the background wallpaper positioned between the application icons, and the central position of the background wallpaper can be covered with the application icons; the color histogram statistic value of the background wallpaper is the appearance probability of each color in the background wallpaper, the higher color histogram statistic value of a color is, the more appearance times of the color is, and the more occupied pixels are, so that the color becomes a main color of the background wallpaper.

Step S203, calculating a Bhattacharyya coefficient between the color histogram statistic value of the application icon and the color histogram statistic value of the background wallpaper;

in the embodiment of the present disclosure, the process of calculating the Bhattacharyya coefficient ρ(p, p′) between the color histogram statistic value of the application icon and the color histogram statistic value of the background wallpaper can be as follows:

ρ(p,p′)=Σᵢ₌₀ⁿ\sqrt{p(i)p′(i)}

wherein p(i) is the color histogram statistic value of the application icon, p′(i) is the color histogram statistic value of the background wallpaper, i is one of indexes of the color histogram, n is the sum, which subtracts the number of the indexes of the color histograms with same colors, of the number of the indexes of the color histogram of the background wallpaper and the number of the indexes of the color histogram of the application icon; for example, the number of the indexes of the color histogram of the background wallpaper is 9, the number of the indexes of the color histogram of the application icon is 6, and the number of the indexes of the two color histograms with same colors is 3, so n is 9+6−3=12; To enhance the calculation efficiency of the Bhattacharyya coefficient, the color histogram statistic value of each application icon can be calculated respectively according to the pixel values of the pixels of the application icons inside an application installation package, and the color histogram statistic values of the application icons are packaged into the application installation package, so that the color histogram statistic values of the application icons can be directly acquired when the Bhattacharyya coefficient needs to be calculated.

Step S204, displaying the application icon with highest Bhattacharyya coefficient on the background wallpaper.

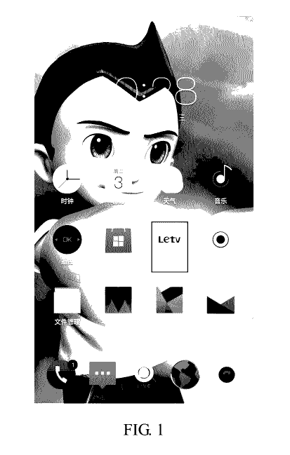

In the step S204, the application icon with highest Bhattacharyya coefficient is the application icon which has largest color difference with the background wallpaper; if the color difference is increased, the visual impact can be correspondingly increased, and the attention of the user can be attracted; as shown in FIG. 3, the increase of the color difference of a replaced LETV icon and the background wallpaper can be very clearly and very obviously seen through the comparison of FIG. 3 and FIG. 1; what need to note is that at least two application icons with different colors under same resolution ratio are packaged in the application installation package; and the steps S104-S104 can be executed one by one on the application icons till all the application icons are completely updated.

The method for replacing the application icon, which is provided by the present disclosure, is capable of enhancing the color difference of the application icon and the wallpaper by replacing the application icon which has the highest Bhattacharyya coefficient with the background wallpaper in time when the users replace the wallpaper to enable the application icon to be very obvious and attract the users to click the application icon, thereby enhancing the click rate of the application icon.

### Second Embodiment

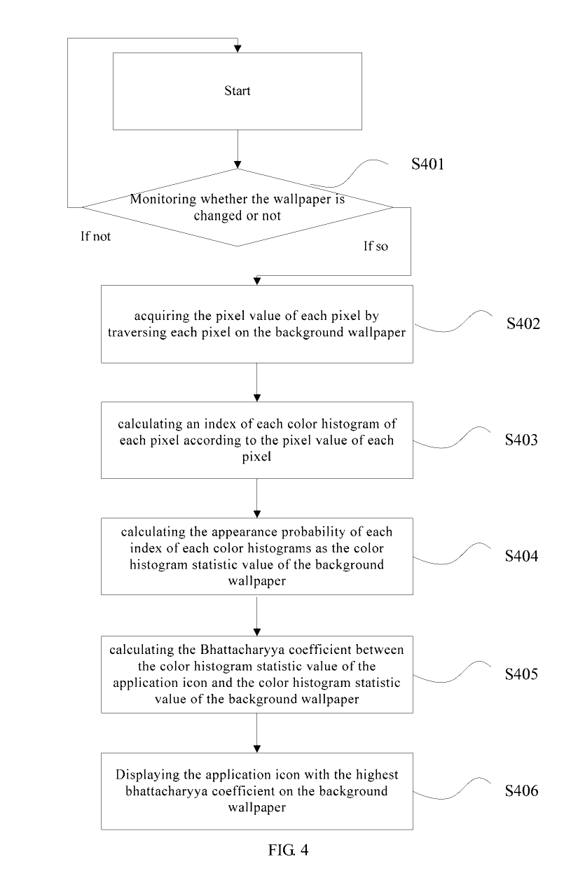

Referring to FIG. 4, the step flow diagram of the method for replacing the application icon, which is provided by the embodiment of the present disclosure, is shown.

The embodiment of the present disclosure provides the method for replacing the application icon. As shown in FIG. 4, the method includes the following steps.

Step S401, monitoring whether the wallpaper is changed;

in the step S401, if the change of the wallpaper is not monitored, the application icon is not replaced, and the step S201 is circularly executed; if the change of the wallpaper is monitored, the operation in the step S402 is executed.

S402, acquiring the pixel value of each pixel by traversing each pixel on the background wallpaper;

in the step S402, the pixel values of the pixels include R values (red values), G values (green values) and B values (blue values); to reduce a calculated amount, the pixels values of the pixels can be equally divided into 32 parts, that is to say, the ranges of the pixel values are equally divided from 0-255 to 0-38, namely the value ranges of the R values, the G values and the B values are all 0-38.

S403, calculating an index of each color histogram of each pixel according to the pixel value of each pixel;

the process of calculating the Index of each color histogram of each pixel according to each pixel value, which is equally divided into 32 parts, of the pixels is as follows:

Index=R+G*+B*32*32

wherein R is the red values of the pixels values which are equally divided into 32 parts, G is the green values of the pixels values which are equally divided into 32 parts, and B is the blue values of the pixels values which are equally divided into 32 parts.

S404, calculating the appearance probability of each index of each color histograms as the color histogram statistic value of the background wallpaper.

S405, calculating the Bhattacharyya coefficient between the color histogram statistic value of the application icon and the color histogram statistic value of the background wallpaper.

S406, displaying the application icon with the highest Bhattacharyya coefficient on the background wallpaper.

The method for replacing the application icon, which is provided by the present disclosure, is capable of enhancing the color difference of the application icon and the wallpaper by replacing the application icon which has the highest Bhattacharyya coefficient with the background wallpaper in time when the users replace the wallpaper to enable the application icon to be very obvious and attract the users to click the application icon, thereby enhancing the click rate of the application icon.

To clearly illustrate the method for replacing the application icon, which is provided by the embodiment of the present disclosure, the embodiment of the present disclosure provides an image of 4*4 pixels for illustration.

16 pixels in all exist in the image of 4*4 pixels, and the pixel values of the 16 pixels are as follows:

(86, 828, 4), (86, 828, 8), (86, 828, 86), (86, 828, 32)
(86, 820, 4), (86, 882, 8), (86, 800, 86), (86, 90, 32)
(86, 820, 4), (32, 882, 8), (40, 800, 86), (56, 90, 32)
(8, 820, 4), (86, 882, 8), (32, 800, 86), (46, 90, 32)

To reduce the complexity degree of the calculation process, the pixel values of the 16 pixels are equally divided into 32 parts, and the divided pixel values are as follows:

(2, 86, 0), (2, 86, 8), (2, 86, 2), (2, 86, 4)
(2, 85, 0), (2, 84, 8), (2, 82, 2), (2, 88, 4)
(2, 85, 0), (4, 84, 8), (5, 82, 2), (7, 88, 4)
(8, 85, 0), (2, 84, 8), (4, 82, 2), (5, 88, 4)

The Indexes of the color histograms of the pixels are calculated according to the formula Index=R+G*32+B*32*32, and the calculated indexes of the color histograms are as follows:

| | | | |
|---|---|---|---|
| 584 | 8538 | 2562 | 4680 |
| 482 | 8474 | 2432 | 4450 |
| 482 | 8472 | 2435 | 4455 |
| 488 | 8474 | 2434 | 4453 |

And the color histogram statistic value p(i) of the integral image can be calculated:

P(481)=1/16

P(482)=2/16

P(584)=1/16

P(1472)=1/16

P(1474)=2/16

P(1538)=1/16

P(2432)=1/16

P(2434)=1/16

P(2435)=1/16

P(2562)=1/16

P(4450)=1/16

P(4453)=1/16

P(4455)=1/16

P(4610)=1/16

### Third Embodiment

Referring to FIG. 5, the structure diagram of the device for replacing the application icon, which is provided by the embodiment of the present disclosure, is shown.

The device for replacing the application icon, which is provided by the embodiment of the present disclosure, is capable of implementing the method for replacing the application icon, which is provided by the embodiment of the present disclosure, as shown in FIG. 5, the device includes:

a wallpaper monitoring module 51, a statistic value calculation module 52, a Bhattacharyya coefficient calculation module 53 and an application icon display module 54.

In the embodiment of the present disclosure, the wallpaper monitoring module 51 is used for monitoring whether the wallpaper is changed, the statistic value calculation module 52 is used for determining the color histogram statistic value of the background wallpaper according to the pixel value of each pixel of the background wallpaper which corresponds to the application icon if the wallpaper is changed, the Bhattacharyya coefficient calculation module 53 is used for calculating the Bhattacharyya coefficient between the color histogram statistic value of the application icon and the color histogram statistic value of the background wallpaper, and the application icon display module 54 is used for displaying the application icon with the highest Bhattacharyya coefficient on the background wallpaper.

In the wallpaper monitoring module 51, the users can change the wallpaper on the desktop of the terminal at any time through the wallpaper setting function of the terminal; the wallpaper is covered with the plurality of the application icons, and the positions and quantity of the application icons cannot be changed when the users change the wallpaper.

In the statistic value calculation module 52, the background wallpaper is positioned within a certain range around the application icon, the length of the background wallpaper is less than or equal to the distance between adjacent left and right application icons, the width of the background wallpaper is less than or equal to the distance between adjacent upper and lower application icons, and the length and width of the background wallpaper are both more than the lengths and widths of the application icons; the overlapped area can appear on the background wallpaper positioned between the application icons, and the central position of the background wallpaper can be covered with the application icons; the color histogram statistic value of the background wallpaper is the appearance probability of each color in the background wallpaper, the higher color histogram statistic value of the color is, the more appearance times of the color is, and the more occupied pixels are, so that the color becomes the main color of the background wallpaper.

In the Bhattacharyya coefficient calculation module 53, the process of calculating the Bhattacharyya coefficient ρ(p, p′) between the color histogram statistic value of the application icon and the color histogram statistic value of the background wallpaper may be as follows:

ρ(p,p′)=Σᵢ₌₀ⁿ\sqrt{p(i)p′(i)}

wherein p(i) is the color histogram statistic value of the application icon, p′(i) is the color histogram statistic value of the background wallpaper, i is one of indexes of the color histogram, n is the sum, which subtracts the number of the indexes of the color histograms with same colors, of the number of the indexes of the color histogram of the background wallpaper and the number of the indexes of the color histogram of the application icon; for example, the number of the indexes of the color histogram of the background wallpaper is 9, the number of the indexes of the color histogram of the application icon is 6, and the number of the indexes of the two color histograms with same colors is 3, so n is 9+6−3=12; to enhance the calculation efficiency of the Bhattacharyya coefficient, preferably, an application icon packaging module can be included and used for calculating the color histogram statistic values of each application icon respectively according to the pixel values of the pixels of the application icons inside the application installation package and calculating the color histogram statistic values of the application icons into the application installation package, so that the color histogram statistic values of the application icons can be directly acquired when the Bhattacharyya coefficient needs to be calculated.

In the application icon display module 54, the application icon with highest Bhattacharyya coefficient is the application icon which has largest color difference with the background wallpaper; if the color difference is increased, the visual impact can be correspondingly increased, and the attention of the user can be attracted; as shown in FIG. 3, the increase of the color difference of the replaced LETV icon and the background wallpaper can be very clearly and very obviously seen through the comparison of FIG. 3 and FIG. 1; and what need to note is that at least two application icons with different colors under same resolution ratio are packaged in the application installation package.

The method for replacing the application icon, which are provided by the present disclosure, is capable of enhancing the color difference of the application icon and the wallpaper by replacing the application icon which has the highest Bhattacharyya coefficient with the background wallpaper in time when the users replace the wallpaper to achieve the very obvious application icon and attract the users to click the application icon, thereby enhancing the click rate of the application icon.

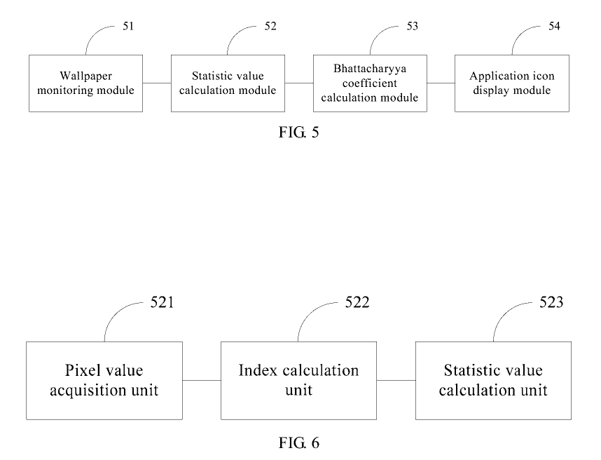

The present disclosure provides a preferred embodiment, as shown in FIG. 6, the statistic value calculation module 52 includes the following units: a pixel value acquisition unit 521, an index calculation unit 522 and a statistic value calculation unit 523.

In the preferred embodiment of the present disclosure, a pixel value acquisition unit 61 is used for acquiring the pixel value of each pixel by traversing each pixel on the background wallpaper, an index calculation unit 62 is used for calculating the index of each color histogram of each pixel according to the pixel value of each pixel, and a statistic value calculation unit 63 is used for the appearance probability of the index of each color histograms as the color histogram statistic value of the background wallpaper.

In the pixel value acquisition unit 61, the pixel value of the pixel include R value (red value), G value (green value) and B value (blue value); to reduce the calculated amount, the pixels value of each pixel can be equally divided into 32 parts, that is to say, the ranges of the pixel values are equally divided from 0-255 to 0-38, namely the value ranges of the R value, the G value and the B value are all 0-38.

In the index calculation unit 62, the process of calculating the Indexes of each color histogram of the pixel according to the pixel value, which are equally divided into 32 parts, of the pixel is as follows:

Index=R+G*32+B*32*32

wherein R is the red value of the pixel value which is equally divided into 32 parts, G is the green value of the pixel value which is equally divided into 32 part, and B is the blue value of the pixel value which is equally divided into 32 parts.

The statistic value calculation module provided by the preferred embodiment of the present disclosure is capable of carrying out simplifying treatment on the pixel values, thereby increasing the calculation efficiency of the histograms indexes and further increasing the calculation efficiency of the color statistic values.

The described device embodiment is only schematic, wherein a unit illustrated as a separating part can be or cannot be physically separated, a part displayed as the unit can be or cannot be a physical unit, namely the part can be positioned on a same place or can be distributed on a plurality of network units; a part of or all of modules can be selected according to actual demand to achieve the object of the scheme of the embodiment; and ordinary technical personnel in the field can understand and execute the scheme under the condition of contributing no creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

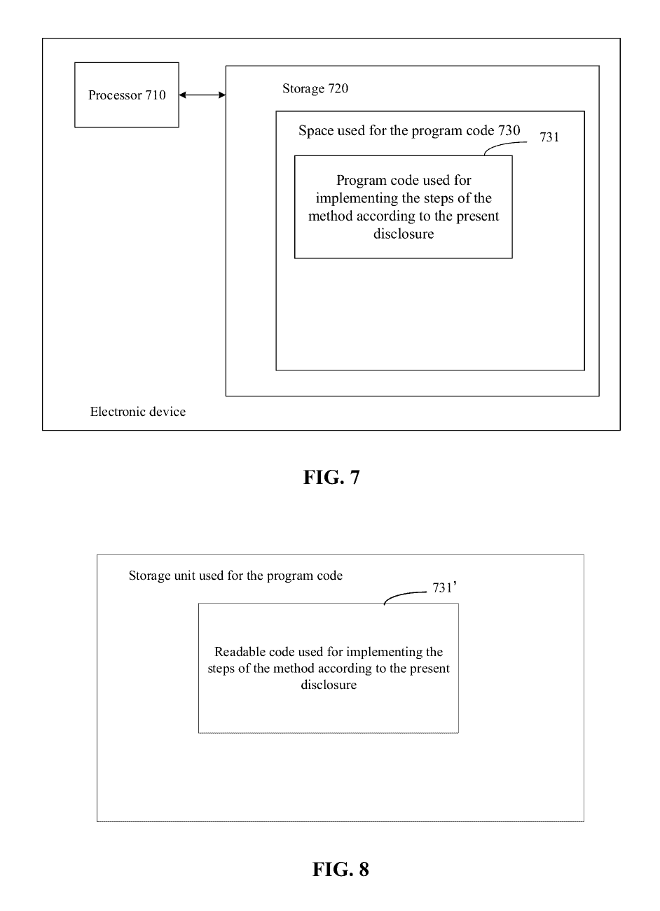

For example, FIG. 7 illustrates a block diagram of an electronic device for executing the method according the disclosure, such as the terminal above. Traditionally, the electronic device includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

What need to finally note is that the embodiments are only used for illustrating the technical solution but not limit the technical solution; even though the present disclosure is illustrated in a detailed fashion referring to the embodiments, ordinary technical personnel in the field should understand: the ordinary technical personnel can still modify the technical solution recorded in the embodiments or equally replace a part of technical characteristics of the technical solution; and the essence of the corresponding technical solution cannot be separated from the spirit and range of the technical solutions of the embodiments of the present disclosure due to the modification or replacement.

What is claimed is:

1. A method for replacing an application icon, applied to a terminal, a wallpaper and the application icon are displayed on a desktop of the terminal, and the method comprises:
monitoring whether the wallpaper is changed;
if yes, determining a color histogram statistic value of the background wallpaper according to a pixel value of each pixel of the background wallpaper which corresponds to the application icon;
calculating a Bhattacharyya coefficient between the color histogram statistic value of the application icon and the color histogram statistic value of the background wallpaper;
displaying the application icon with highest Bhattacharyya coefficient on the background wallpaper.

2. The method according to claim 1, wherein determining the color histogram statistic value of the background wallpaper according to the pixel value of each pixel of the background wallpaper which corresponds to the application icon, comprises:
acquiring the pixel value of each pixel by traversing each pixel on the background wallpaper;
calculating an index of each color histogram of each pixel according to the pixel value of each pixel;
calculating the appearance probability of the index of each color histogram as the color histogram statistic value of the background wallpaper.

3. The method according to claim 2, wherein calculating the index of each color histogram of each pixel according to the pixel value of each pixel, comprises:
equally dividing the pixel value of each pixel into 32 parts;
a process of calculating the Index of each color histogram of each pixel according to the pixel value, which is equally divided into 32 parts, of each pixel is as follows:
Index=R+G*32+B*32*32
wherein R is red value of each pixel value which is equally divided into 32 parts, G is green value of each pixel value which is equally divided into 32 parts, and B is blue value of each pixel value which is equally divided into 32 parts.

4. The method according to the claim 1, wherein a process of calculating the Bhattacharyya coefficient ρ(p,) between the color histogram statistic value of the application icon and the color histogram statistic value of the background wallpaper is as follows:
ρ(p,p′)=Σᵢ₌₀ⁿ\sqrt{p(i)p′(i)}
wherein p(i) is the color histogram statistic value of the application icon, p′(i) is the color histogram statistic value of the background wallpaper, i is one of the indexes of the color histogram, n is the sum, which subtracts the number of the indexes of the color histograms with same colors, of the number of the indexes of the color histogram of the background wallpaper and the number of the indexes of the color histogram of the application icon.

5. The method according to the claim 1, wherein at least two application icons with different colors under same resolution ratio are packaged in an application installation package.

6. The method according to the claim 1, wherein before monitoring whether the wallpaper is changed, the method further comprises:
calculating the color histogram statistic value of each application icon respectively according to the pixel value of each pixel of each application icon inside the application installation package and packaging the color histogram statistic value of each application icon into the application installation package.

7. The method according to the claim 1, wherein the length of the background wallpaper is less than or equal to the distance between adjacent left and right application icons, the width of the background wallpaper is less than or equal to the distance between adjacent upper and lower application icons, and the length and width of the background wallpaper are both more than the lengths and widths of the application icons.

8. An electronic device for replacing an application icon, comprising:
at least one processor; and
a memory communicably connected with the at least one processor for storing instructions executable by the at least one processor, wherein execution of the instructions by the at least one processor causes the at least one processor to:
monitor whether a wallpaper is changed;
determine a color histogram statistic value of the background wallpaper according to a pixel value of each pixel of the background wallpaper which corresponds to the application icon if the wallpaper is changed;
calculate Bhattacharyya coefficient between the color histogram statistic value of the application icon and the color histogram statistic value of the background wallpaper;
display the application icon with highest Bhattacharyya coefficient on the background wallpaper.

9. The electronic device according to claim 8, wherein determine a color histogram statistic value of the background wallpaper according to the pixel value of each pixel of the background wallpaper which corresponds to the application icon if the wallpaper is changed, comprises:
acquiring the pixel value of each pixel by traversing each pixel on the background wallpaper,
calculating an index of each color histogram of each pixel according to the pixel value of each pixel,
calculating the appearance probability of the index of the color histograms as the color histogram statistic value of the background wallpaper.

10. The electronic device according to claim 9, wherein calculating index of each color histogram of each pixels according to the pixel value of each pixel comprises:
equally dividing the pixel value of each pixel into 32 parts;
the process of calculating the Index of the color histogram of each pixel according to the pixel value, which is equally divided into 32 parts, of each pixel is as follows:
Index=R+G*32+B*32*32
wherein R is red value of each pixel value which is equally divided into 32 parts, G is green value of each pixel value which is equally divided into 32 parts, and B is blue value of each pixel value which is equally divided into 32 parts.

11. The electronic device according to claim 8, wherein the process of calculating the Bhattacharyya coefficient ρ(p, p′) between the color histogram statistic value of the application icon and the color histogram statistic value of the background wallpaper is as follows:
ρ(p,p′)=Σᵢ₌₀ⁿ\sqrt{p(i)p′(i)}
wherein p(i) is the color histogram statistic value of the application icon, p′(i) is the color histogram statistic value of the background wallpaper, i is one of the indexes of the color histogram, n is the sum, which subtracts the number of the indexes of the color histograms with same colors, of the number of the indexes of the color histogram of the background wallpaper and the number of the indexes of the color histogram of the application icon.

12. The electronic device according to the claim 8, wherein at least two application icons with different colors under same resolution ratio are packaged in an application installation package.

13. The electronic device according to the claim 8, wherein execution of the instructions by the at least one processor causes the at least one processor to further:
calculate the color histogram statistic value of each application icon respectively according to the pixel value of each pixel of each application icon inside the application installation package and packaging the color histogram statistic value of each application icon into the application installation package.

14. The electronic device according to the claim 8, wherein the length of the background wallpaper is less than or equal to the distance between adjacent left and right application icons, the width of the background wallpaper is less than or equal to the distance between adjacent upper and lower application icons,
and the length and width of the background wallpaper are both more than the lengths and widths of the application icons.

15. A non-transitory computer readable medium storing executable instructions that, when executed by an electronic device, cause the electronic device to:
monitor whether a wallpaper is changed;
determine a color histogram statistic value of the background wallpaper according to a pixel value of each pixel of the background wallpaper which corresponds to the application icon if the wallpaper is changed;
calculate Bhattacharyya coefficient between the color histogram statistic value of the application icon and the color histogram statistic value of the background wallpaper;
display the application icon with highest Bhattacharyya coefficient on the background wallpaper.

16. The non-transitory computer readable medium according to claim 15, wherein determine the color histogram statistic value of the background wallpaper according to the pixel value of each pixel of the background wallpaper which corresponds to the application icon, comprises:
acquiring the pixel value of each pixel by traversing each pixel on the background wallpaper;
calculating an index of each color histogram of each pixel according to the pixel value of each pixel;
calculating the appearance probability of the index of each color histogram as the color histogram statistic value of the background wallpaper.

17. The non-transitory computer readable medium according to claim 16, wherein calculating the index of each color histogram of each pixel according to the pixel value of each pixel, comprises:
equally dividing the pixel value of each pixel into 32 parts;
calculating the Index of each color histogram of each pixel according to the pixel value, which is equally divided into 32 parts, of each pixel is as follows:
Index=R+G*32+B*32*32
wherein R is red value of each pixel value which is equally divided into 32 parts, G is green value of each pixel value which is equally divided into 32 parts, and B is blue value of each pixel value which is equally divided into 32 parts.

18. The non-transitory computer readable medium according to the claim 15, wherein a process of calculating the Bhattacharyya coefficient ρ(p, p′) between the color histogram statistic value of the application icon and the color histogram statistic value of the background wallpaper is as follows:
ρ(p,p′)=Σᵢ₌₀ⁿ\sqrt{p(i)p′(i)}
wherein p(i) is the color histogram statistic value of the application icon, p′(i) is the color histogram statistic value of the background wallpaper, i is one of the indexes of the color histogram, n is the sum, which subtracts the number of the indexes of the color histograms with same colors, of the number of the indexes of the color histogram of the background wallpaper and the number of the indexes of the color histogram of the application icon.

19. The non-transitory computer readable medium according to the claim 15, wherein at least two application icons with different colors under same resolution ratio are packaged in an application installation package.

20. The non-transitory computer readable medium according to the claim 15, wherein before monitoring whether the wallpaper is changed, the electronic device is further caused to:
calculate the color histogram statistic value of each application icon respectively according to the pixel value of each pixel of each application icon inside the application installation package and packaging the color histogram statistic value of each application icon into the application installation package.
